(19) United States
(12) Patent Application Publication
(10) Pub. No.: US 2025/0190177 A1
(43) Pub. Date: Jun. 12, 2025

(54) SPATIAL ARCHITECTURE FOR ATTENTION MECHANISMS

(71) Applicant: UNTETHER AI CORPORATION, Toronto (CA)

(72) Inventors: Andrew Vincent ROCK, Toronto (CA); David RAMON PRADOS, Toronto (CA); John KITAMURA, Toronto (CA)

(21) Appl. No.: 18/957,033

(22) Filed: Nov. 22, 2024

Related U.S. Application Data
(60) Provisional application No. 63/608,539, filed on Dec. 11, 2023.

(51) Int. Cl. G06F 7/78; G06F 5/01; G06F 15/80

(52) U.S. Cl. CPC G06F 7/785; G06F 5/017; G06F 15/80

(57) ABSTRACT

The present specification discloses a computing device architecture and method for executing computationally intensive attention mechanisms, as commonly utilized in transformer models for artificial intelligence. In an embodiment, the device includes a row of interconnected processing elements (PEs), each linked to dedicated coefficient memory units (CRAMs) and controlled by a central controller. By employing a diagonal-offset and transposition technique for matrix coefficients, the architecture enables efficient execution of Generalized Matrix-Vector (GEMV) operations.

### CROSS-RELATED APPLICATIONS

The present specification claims priority to U.S. Provisional Patent Application 63/608,539, filed Dec. 11, 2023, titled “Mapping Attention Mechanisms (Transformer) Function to Spatial Architecture (SIMD or At-Memory Processing)”. The contents are incorporated herein by reference.

### Color Drawing

The specification contains at least one drawing executed in color. Copies of this patent or patent application publication with color drawing(s) will be provided by the Office upon request and payment of the necessary fee.

### BACKGROUND

Attention mechanisms, such as those used in transformer architectures, have become essential for a wide range of machine learning and artificial intelligence applications, particularly in natural language processing and computer vision. These mechanisms require significant computational resources, especially for matrix operations involving query, key, and value matrices, which can quickly escalate in complexity. The computation of attention scores typically involves matrix multiplication and subsequent operations that scale with the square of the sequence length, or O(T²), creating substantial demands on memory bandwidth and processing speed. Efficiently handling these resource-intensive calculations remains a challenge.

### SUMMARY

An aspect of the specification provides a method of operating a computing device having a plurality of processing elements connected to a controller, the method including: receiving, by the controller, at least a portion of an input matrix into the processing elements; the input matrix having undergone a pre-scaling operation; loading, by the controller, a coefficient into a memory unit associated with each of the processing elements in a diagonally-offset configuration; transposing the coefficients by shifting each coefficient from its respective memory unit in a first processing element to another memory location in an adjacent processing element; executing, within the processing elements, a computational operation based on the transposed coefficients within the processing elements; and, controlling, by the controller, an output device based on the executed computational operation.

An aspect of the specification provides a method wherein the computational operation is a multi-step computational operation based on one or more of a GEMV operation, a Softmax operation, and/or an attention operation.

An aspect of the specification provides a method wherein the pre-scaling operation calculates e\hat{ }x as 2\hat{ }x by applying a pre-scaling factor.

An aspect of the specification provides a method, wherein the approximation is achieved by applying a hardware bit-shifting operation within each processing element.

An aspect of the specification provides a method, wherein the diagonally-offset configuration of coefficients is achieved using a mask-controlled selective shifting operation across a subset of processing elements.

An aspect of the specification provides a method, wherein the transposing of coefficients includes a rotation operation performed by a rotator link connecting adjacent processing elements, the rotation configured to align coefficients for matrix-vector multiplication.

An aspect of the specification provides a method, wherein the pre-scaling operation includes subtracting the maximum value from all elements in the input matrix to enhance numerical stability during subsequent computations.

An aspect of the specification provides a method, wherein the computational operation includes a GEMV-Broadcast operation in which a single input element is broadcast across all processing elements.

An aspect of the specification provides a method, wherein the computational operation includes a GEMV-Reduce operation that aggregates intermediate results from multiple processing elements using a reduce-sum operation.

An aspect of the specification provides a method, wherein the transposition of coefficients includes a skewing operation that aligns diagonally-offset coefficients for parallel processing.

An aspect of the specification provides a method, further including performing a normalization operation on the results of the computational operation by broadcasting an inverse sum value across the processing elements.

An aspect of the specification provides a method, wherein the memory unit associated with each processing element is a coefficient random access memory (CRAM) configured to store at least 64 coefficients.

An aspect of the specification provides a method, further including executing a computational operation in which two separate computational operations are performed in parallel by distinct groups of processing elements.

An aspect of the specification provides a method, wherein the diagonally-offset configuration is achieved by sequentially writing coefficients into memory locations in a staggered pattern across the processing elements.

An aspect of the specification provides a method, wherein the transposing of coefficients utilizes four parallel groups of rotator links to perform concurrent rotation operations across subsets of the processing elements.

An aspect of the specification provides a method, wherein the computational operation includes a Softmax operation that utilizes the pre-scaled coefficients for exponentiation and normalization.

An aspect of the specification provides a method, further including performing an activation operation, including one of pooling, summation, or averaging, on the output of the computational operation.

An aspect of the specification provides a method, wherein the input matrix is divided into smaller submatrices, each submatrix being processed independently across the processing elements.

An aspect of the specification provides a method, wherein the computational operation involves a bi-directional GEMV operation, wherein input data is processed simultaneously in both forward and reverse directions across the processing elements.

An aspect of the specification provides a computing device and method for executing computationally intensive operations associated with attention mechanisms, leveraging both unique hardware and software optimizations.

From a hardware perspective, the specification provides a device includes advanced features that extend beyond traditional GEMV-only architectures, including:

A programmable SHIFT register integrated into the multiplier, facilitating efficient computations, such as those required for Softmax functions.

K-masks for selectively loading coefficients into processing elements, enabling staggered or diagonalized configurations for optimized data alignment.

Rotator cuffs, which enable efficient loading, transposing, and alignment of coefficients across a plurality of processing elements.

Reduce-Sum and Reduce-Max hardware units, specifically designed to accelerate operations involved in Softmax computations and handling transposed coefficients.

From a software perspective, the specification provides methods to exploit these hardware features for accelerating non-GEMV operations, including:

Utilizing the programmable SHIFT register in non-obvious ways to approximate exponential functions, such as e\hat{ }x, with reduced computational overhead.

Exploiting properties of diagonalized coefficients to perform efficient transpositions directly within hardware.

Implementing bi-directional GEMV operations where applicable, further enhancing computational efficiency.

These advancements can individually and collectively address various computational challenges associated with attention mechanisms, providing a novel architecture that accelerates operations typically constrained by conventional GEMV hardware.

### BRIEF DESCRIPTION OF THE DRAWINGS

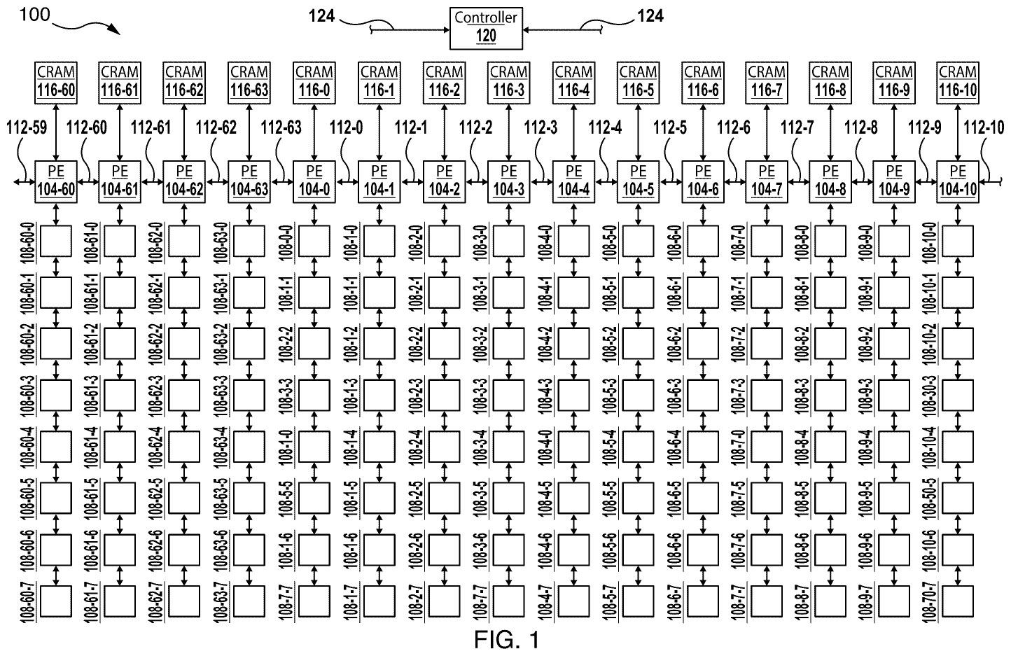

FIG. 1 is a diagram of an example computing device including a plurality of processing elements (PE)s.

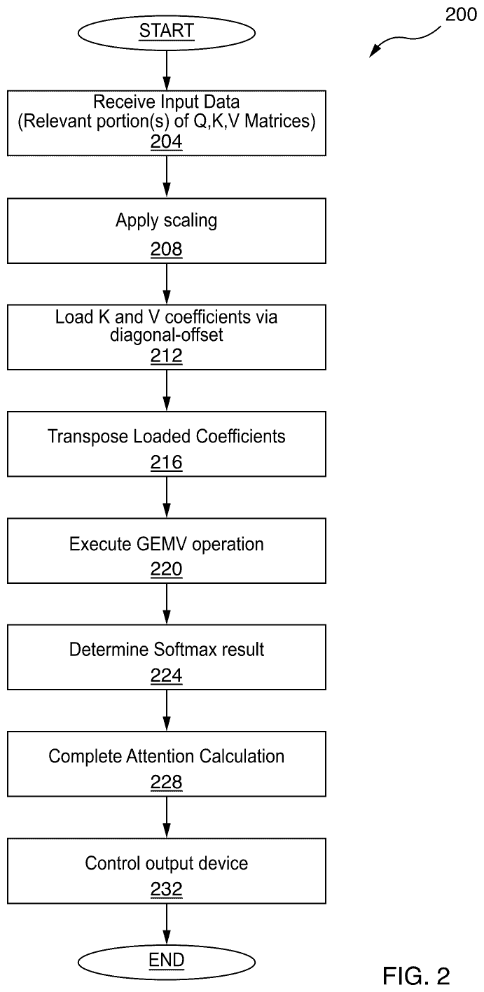

FIG. 2 is a flowchart of a method for operating a computing device, such as the device of FIG. 1.

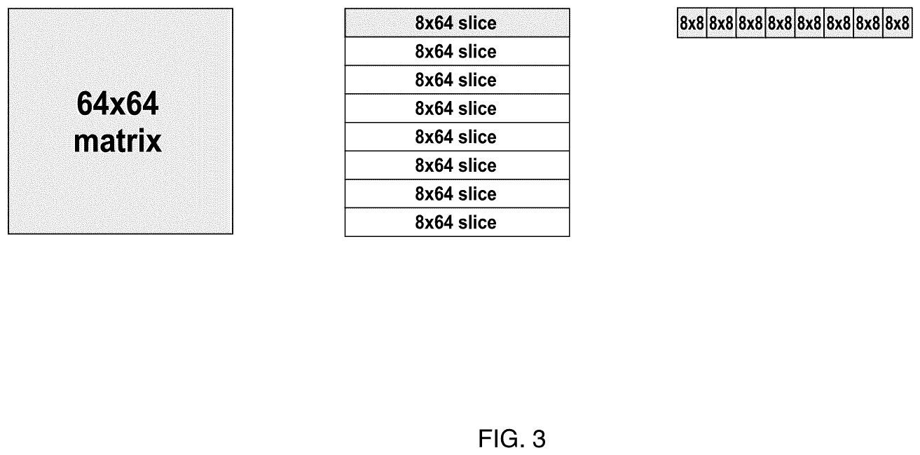

FIG. 3 shows an example of a matrix sliced into submatrices, detailing the initial configuration for coefficient loading.

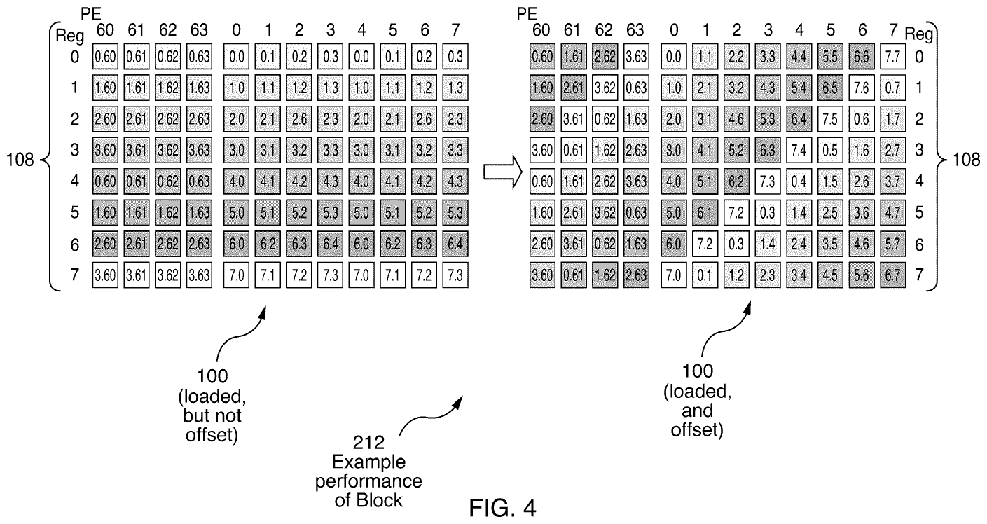

FIG. 4 illustrates the loading of coefficients into PEs and the staggered offset process for alignment.

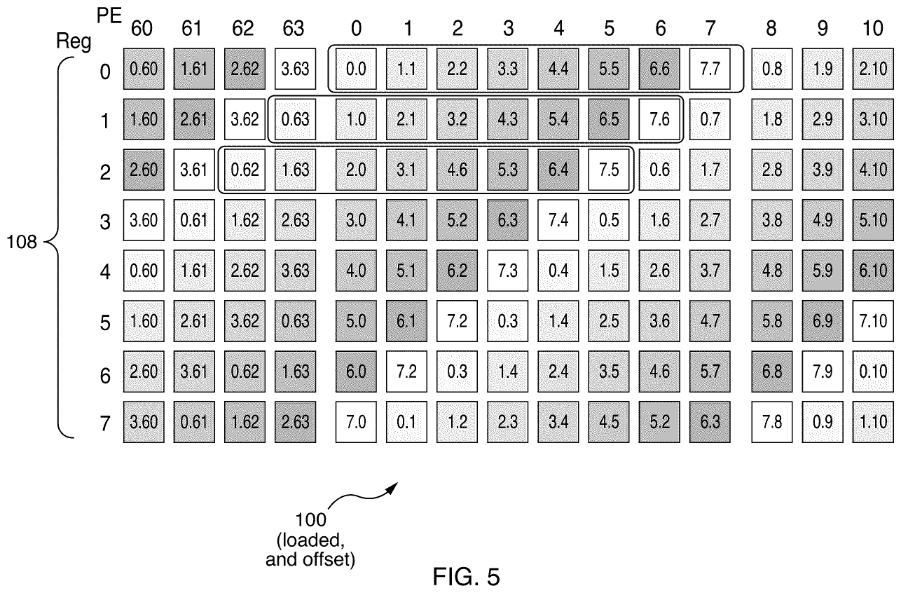

FIG. 5 depicts the device after completion of the loading and offset process, showing staggered coefficient arrangement across PEs.

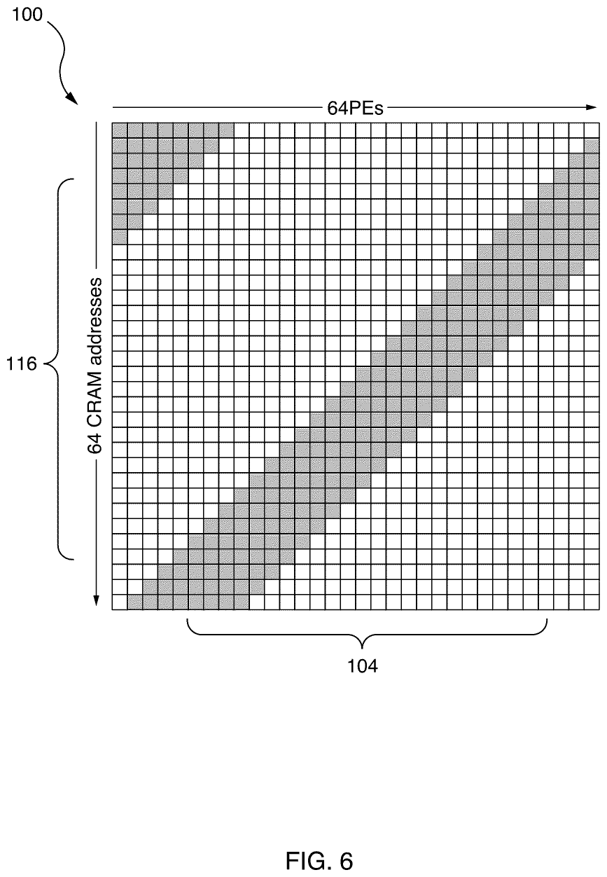

FIG. 6 represents the writing process for a diagonal stripe of coefficients across CRAM addresses.

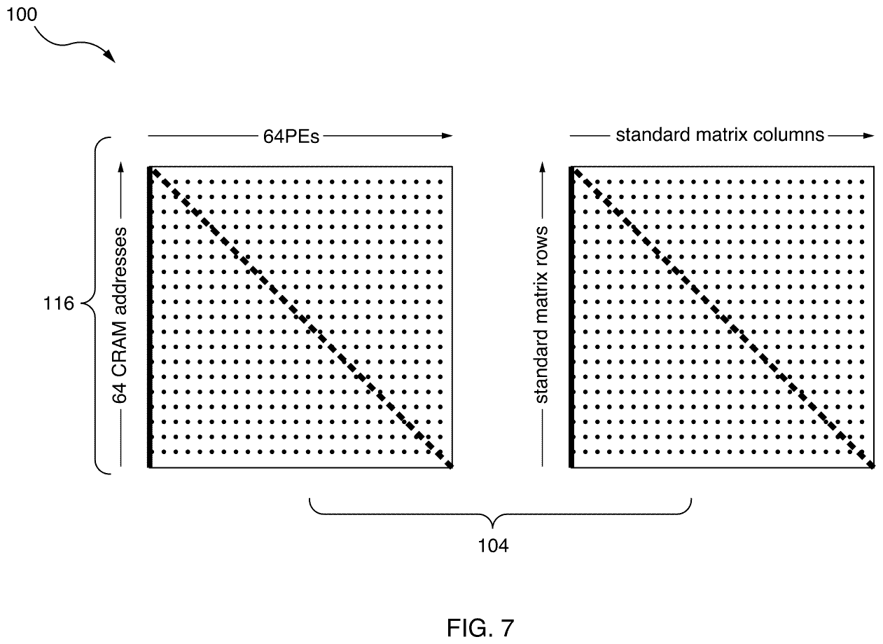

FIG. 7 shows a comparison between a standard coefficient matrix and a diagonally-offset matrix to facilitate transposition.

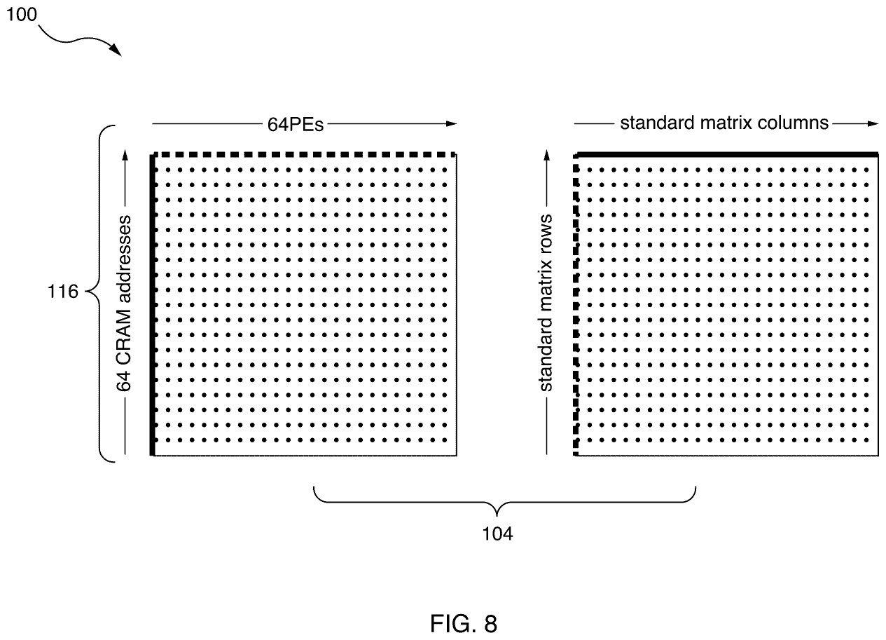

FIG. 8 shows the result of a transposition on a standard coefficient matrix.

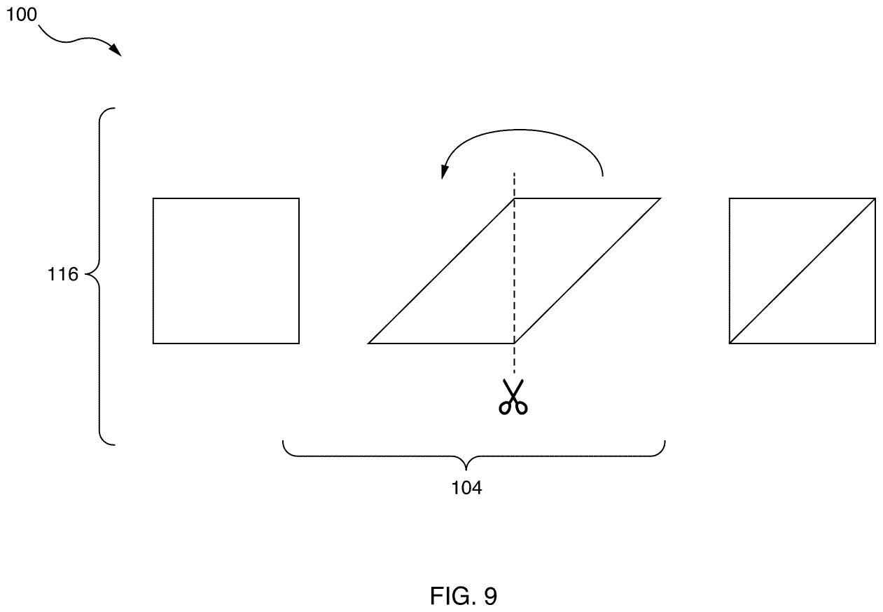

FIG. 9 shows the skewing process to align diagonally-offset coefficients for matrix manipulation.

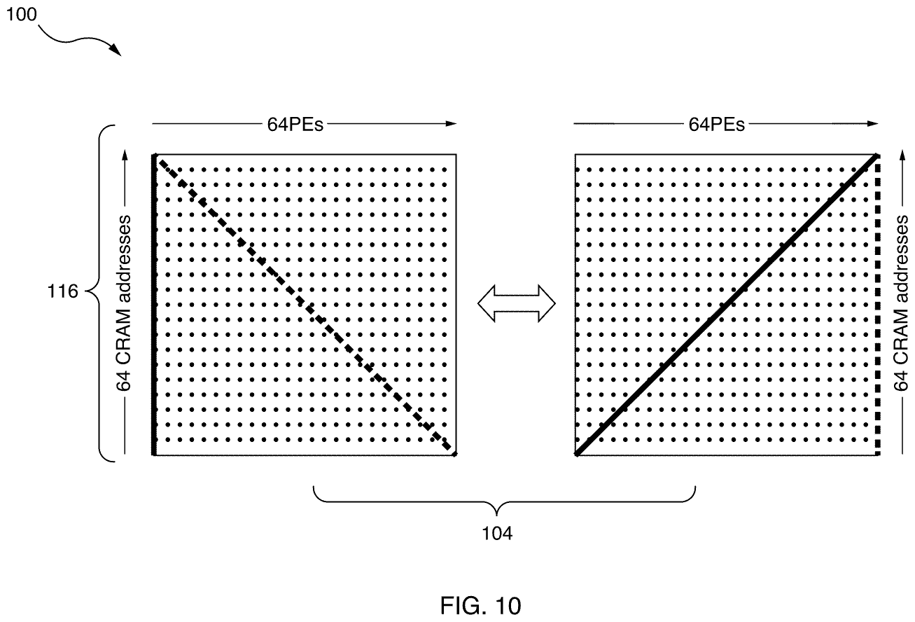

FIG. 10 shows the result of skewing, where coefficients are aligned for the GEMV calculation framework.

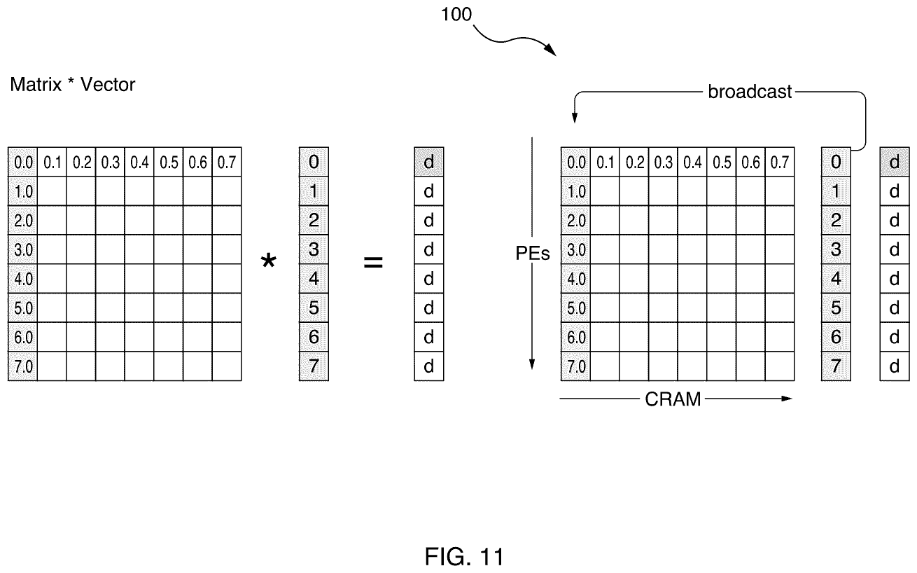

FIG. 11 shows a representation of the GEMV-Broadcast mode, comparing standard matrix-vector multiply with broadcast operations in device 100.

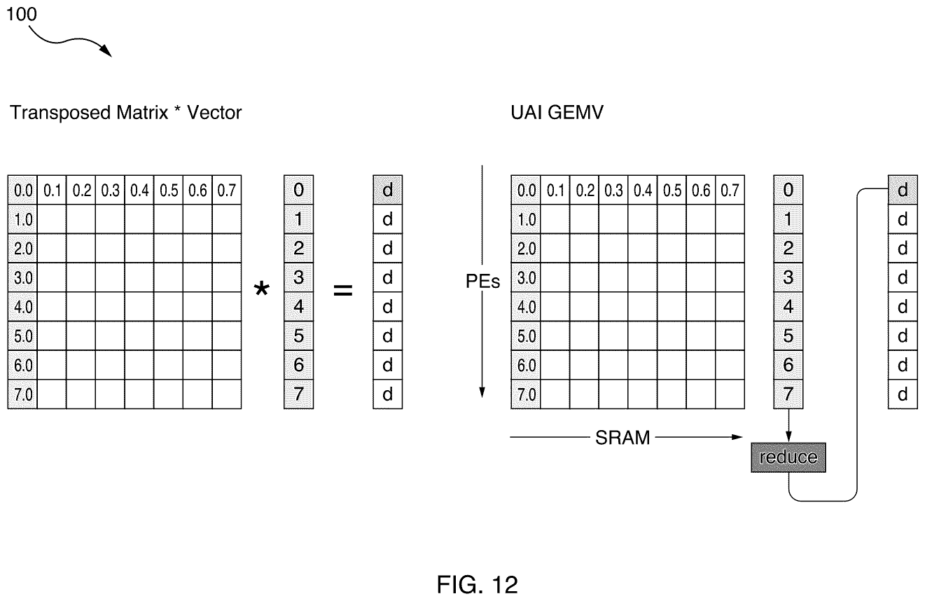

FIG. 12 shows a representation of the GEMV-Reduce mode for a transposed GEMV operation, highlighting the Reduce_Sum accumulation process across PEs.

### DETAILED DESCRIPTION

FIG. 1 shows an example computing device 100 that includes a plurality of processing elements 104-0, 104-1, 104-2 . . . 104-63. (Collectively, these will be referred to as processing elements 104 or PEs 104, and generically, these will be referred to as processing element 104 or PE 104. This nomenclature applies throughout this specification).

In a present embodiment, a single row of sixty-four PEs 104 are shown in FIG. 1, but other configurations are contemplated, such as multidimensional arrays of PEs 104. PEs 104 are arranged in a ring architecture for enabling data flow between neighboring elements. For simplicity, only a subset of PEs 104 from the row are shown, and are shown in a fashion to emphasize the ring architecture. (Specifically, PE 104-60, PE 104-61 . . . PE 104-63, PE 104-0, PE 104-1, . . . PE104-10 are shown. The remaining PEs 104 can be inferred but are omitted for visual simplification.)

Other architectures for device 100 are contemplated; for example, in variants of device 100 the PEs 104 may be logically and/or physically arranged in a two-dimensional grid.

Each PE 104 is connected to a plurality of registers 108. In a present embodiment, a single PE 104 has eight registers 108, but other configurations are contemplated, such as sixteen, or more registers per PE 104 may also be used.

Each PE 104 is connected to its adjacent PE 104 via a link 112. In a present embodiment link 112 may be referred to as a “rotator cuff” link 112 as it enables data to be passed or “rotated” between neighboring PEs 104, facilitating coordinated processing and data sharing along the ring of PEs 104. The term “rotator” is chosen to aid in understanding certain embodiments discussed herein, but is not to be construed as limiting as to the exact type of hardware chosen to implement links 112. However, link 112 serves as a “rotator cuff” with connectivity and buffering capabilities, for independently rotating and temporarily storing data, enabling controlled data rotation across the processing elements. Although sixty-four rotator links 112 are shown, in a present embodiment they are configured in four parallel groups to execute concurrent rotation operations, allowing device 100 to perform four rotation tasks simultaneously across the row of PEs 104. This parallelized structure supports efficient data manipulation and other operations as described in further detail below.

Each PE 104 is also connected to a coefficient random access memory unit or CRAM 116. As will be explained further below, each CRAM 116 can hold at least sixty-four coefficients for its respective PE 104 in a present embodiment, even though those memory locations are not expressly shown in FIG. 1. (It can be noted that current PE hardware can hold 512 or 256 coefficients, but the example of sixty-four is used here.) A “CRAM row” refers to a specific indexed set of coefficient values across all CRAMs 116, one in for each PE 104, that collectively form a contiguous data “row” accessible across the PEs.

PEs 104 and related registers 108, links 112 and CRAMs 116 are controlled by at least one controller 120 connected via a bus 124. For visual simplicity, bus 124 is not shown as connected to PEs 104, but such connection will be understood by a person skilled in the art.

Overall, the computing device 100 may function as a Single Instruction, Multiple Data (SIMD) computing device, at-memory computing device, or spatial-architecture computing device. U.S. Pat. No. 11,881,872, which is incorporated herein by reference, may be referenced for additional possible configurations concerning the device 100.

As shown in FIG. 1, the processing elements 104 (with, or without the controller 120 and bus 124) may be referred to as a “row.” While not shown in FIG. 1, eight (or other numbers) of “rows” plus one or more controllers may be called a “bank”. In general terms, a “bank” can be described as a logical grouping of PEs 104 that collectively perform a function, especially since the term could vary by implementation. Multiple banks may be connected to form a computing device with higher processing capacity.

The controller 120 can be connected to a subset of processing elements 104, such as by bus 124, and/or include a direction connection to only the “outermost” (parenthesis added due to the fact that this is a ring architecture) one or more of PEs 104 (e.g. PE 104-0 and PE 104-63) or several PEs 104. The controller 120 is a processor (e.g., microcontroller, etc.) that may be configured with instructions to control the connected processing elements 104. (Example instructions will be discussed in greater detail below with reference to method 200.)

The controller 120 may further control loading/retrieving of data to/from the processing elements 104, control the communication among processing elements 104 via links 112, and/or control other functions for the processing elements 104. A plurality of controllers 120 may be provided, in which case one or more controllers 120 can be connected to each other for mutual communications. Controllers 120 can be arranged in a hierarchy, in which, for example, a main controller controls sub-controllers, which in turn control subsets of processing elements 104.

As will be explained in further detail below, each PE 104 can include circuitry to perform one or more operations, such as addition, multiplication, bit shifting, multiplying accumulations, etc. By way of non-limiting example, each PE 104 can include a multiplying accumulator and supporting circuitry. A PE 104 can additionally or alternatively include an arithmetic logic unit (ALU) or similar.

The processing elements 104 can operate on an input stream of data, which may be marched through the processing elements 104 via links 112 and undergo simultaneous operations by the processing elements 104 to generate a resulting output stream of data.

The controller 120 may provide a stream of instructions to the processing elements 104 via the bus 124 and may command the processing elements 104 to execute the instructions in a simultaneous/parallel manner on their respective elements of data.

During operation, any of the processing elements 104 may be blocked if there is no data ready or no instruction provided. A block processing element 104 may block one or more other processing elements 104 that require a result from the block processing element 104. Also, it can be the case that the specific computation specified by the instruction dictates the time it takes.

Hence, for a stream of instructions 116, the total time to execute may vary. Often, there is data dependency between processing elements 104 or subsets of processing elements. Further, when multiple processing-element arrays (not shown in FIG. 1) or multiple devices 100 are connected to operate together, the total amount of time to execute instructions across such processing-element arrays 102 or devices 100 can become highly interdependent.

The processing elements 104, plurality of registers 108, links 112, CRAM 116, controller 120 and bus 124 are simplified for sake of explanation in this specification. The above indicated US patent may be referenced for further details.

Referring now to FIG. 2, a method 200 is depicted in the form of a flowchart for operating a computing device to effect transpose operations and related functions. Method 200 can be used to control device 100 or a variant thereof. When method 200 is implemented on computing device 100, the method is performed by controller 120, coordinating the activities of processing elements (PEs) 104 and associated memory units.

An introductory, high-level overview of method 200 will be provided first, followed by a more detailed discussion of each of the method blocks.

### Method 200: High-Level Overview

Block 204 comprises receiving input data, including query, key, and value matrices (Q, K, and V matrices). This data may be loaded into processing elements 104 and organized for parallel processing. The controller 120 initiates data loading based on the configuration and input requirements. If insufficient PEs 104 are available for the entirety of the matrices, or if only portions of the matrices need be processed, then the Q, K, and V matrices can be stored in a buffer or other temporary storage (not shown in FIG. 1) and “chunked” with portions loaded into PEs 104 for further processing.

Block 208 comprises applying a scaling factor to the input data, typically within the Q, K, or V matrices, (or the portions thereof, as per the capacity of device 100 of FIG. 1) to enhance computational stability in subsequent Softmax calculations. This scaling operation can address the limitations of hardware precision by adjusting values to a manageable range, particularly beneficial when approximations are introduced for efficiency. For instance, in this embodiment, a base-2 scaling approach can be employed, whereby an approximation of 2^{x} replaces e^{x} in the exponentiation step.

(It is to be understood that while scaling is as a step in the process, it need not occur during the computation. Rather, scaling can be pre-computed on either the coefficients of the Q or K matrices, Q being presently preferred. As discussed below, one can therefore view block 208 as “pre-scaling” as having occurred before block 204. This is an example of how the blocks in method 200 need not be performed in the exact order shown, as block 208 can be performed at compile time, and therefore “pre-scaled” prior to performance of block 204. In this variant, at block 204 the input data—including the pre-scaled Q matrix—is received).

Block 212 comprises loading key (K) and value (V) coefficients via a diagonal-offset configuration. (The remainder of the Q, K and V matrices can be stored elsewhere). Block 212 provides for each PE 104 receiving a subset of the coefficients for parallel processing. The diagonal-offset configuration aligns the loading process with the architecture of device 100, distributing data in a way that facilitates subsequent operations.

Block 216 comprises transposing the loaded coefficients. As will be discussed in greater detail below, block 216 arranges the loaded coefficients to enable the matrix operations as per this specification. Controller 120 configures each PE 104 to handle the transposition locally, utilizing device 100's SIMD capabilities, including links 112, to rearrange data across PEs 104. This transposed configuration aligns with the GEMV functions for matrix-vector multiplication, for eventual fulfilment of the entire attention mechanism with reduced computational overhead.

Block 220 comprises executing a Generalized Matrix-Vector (GEMV) operation. This operation leverages the coefficient values and matrix data within each PE 104 to perform calculations in parallel. Controller 120 synchronizes the GEMV operation across PEs 104, enabling simultaneous processing of multiple data elements.

Block 224 comprises determining the Softmax result. Following the GEMV operation, each PE 104 computes part of the Softmax function, weighting inputs in the attention mechanism. Controller 120 may collect and aggregate these results as required by the specific application.

Block 228 comprises completing the attention calculation. This finalizes the attention mechanism's computations based on the Softmax results, combining data to generate output values. The output can then be used in subsequent processing stages or relayed as part of a larger data flow.

Block 232 comprises controlling an output device or relaying processed data for further actions. This can include, for example, directing the computed attention values to an external system or a downstream processor. This stage of data typically goes to a “Feed Forward” block (not shown) which makes inferences of the data. Other examples include directing outputs to external processing systems or data storage units; transmitting data through communication interfaces; controlling visualization units; controlling embedded system components, or peripheral devices for actuation; interfacing with real-time data analytics systems; or providing feedback to audio-visual systems. These are non-limiting examples.

### Method 200: Detailed Discussion

To elaborate in more detail on method 200, device 100 and its variants can be configured to execute method 200 in order to process the Softmax equation, expressed as:

$$s ( {x}_{i} ) = \frac{{e}^{{x}_{i}}}{{\sum }_{j = 1}^{n} {e}^{{x}_{j}}}$$

And in turn, to process the Attention equation, expressed as:

$$Attention ( Q , K , V ) = softmax ( \frac{{QK}^{T}}{\sqrt{{d}_{k}}} ) V$$

As understood by those skilled in the art, the Softmax equation and Attention equation can be used for transformers in artificial intelligence (AI) applications.

To further elaborate on block 204, an initialization is effected at block 204, where relevant portions of the Q, K, and V matrices are loaded into processing elements (PEs) 104. With a sufficient number of PEs 104, the entirety of the Q, K, and V matrices can be loaded simultaneously, allowing the device 100 to operate on all matrix elements together in parallel. However, if the number of available PEs 104 is limited, the matrices are processed in “chunks” according to the available capacity, with each chunk sequentially loaded and processed across multiple cycles. This chunking approach enables flexible adaptation to different hardware configurations while still leveraging the device's parallel processing capabilities. It is to be understood that FIG. 1 and device 100 focus on illustrating the PEs 104 particularly involved with block 208, block 212, and block 216.

To further elaborate on block 208, controller 120 manages the scaling factor application, which can include pre-scaling by constants such as 1/ln(2) to streamline the Generalized Matrix-Vector multiplication (GEMV) operations across PEs 104. By pre-scaling, the architecture can take advantage of the rotator link 112 connectivity among PEs 104, for coordinating data movement so that subsequent operations on these values are less prone to overflow or underflow. This approach can leverage the hardware-specific efficiencies and supports the mathematical integrity of the attention mechanism calculations across varying data ranges.

In an embodiment, the scaling strategy employed in Block 208 also involves a series of calculated adjustments to maintain stability and simplify computations in the hardware of device 100 for implementing the Softmax function. For instance, the controller 120 manages the following operations, drawing from hardware-efficient approximations for optimized data handling within each PE 104:

Receiving initial value: Initially, controller 120 configures each relevant PE 104 to receive “x”, a floating point value.

Adjusting for Numerical Stability: Controller 120 performs a stabilization step that configures each PE 104 to shift the input floating point value x by subtracting the maximum value within the current chunk of data (i.e., x:=x−max(x)). Max(x) can be done by a Row-Reduce Max operation inherent to device 100. This technique in machine learning can help stabilize calculations by normalizing values around zero, thereby reducing the risk of overflow and underflow in subsequent operations. This can be efficiently performed using row-reduction hardware across PEs 104.

Rounding for Simplification: Following the stabilization step, controller 120 may perform a rounding approximation step that approximates values by rounding x to an integer. (i.e. x:=round(x)). This rounding step can reduce the complexity of calculations within each PE 104, as fractional components are dropped. While this introduces an approximation, empirical tests indicate that accuracy is not substantially affected in this architecture, and this rounding allows the architecture to employ simpler, integer-based operations in later steps. Expressed differently, empirical data indicates that the simplifications introduced by integer rounding and 2^{x} approximations still maintain the functional integrity of transformer operations, thereby aligning well with the design of device 100 and its constraints to delivery and accuracy requirements of typical AI applications

Approximating Exponentials with Left Shifts: Next, an e^{x} approximation step is performed. To approximate e^{x} in a hardware-efficient way, controller 120 directs each PE 104 to compute 2^{x} instead, (i.e. p:=2^{x}) achieved via bitwise left-shifting by x. Specifically, the operation 2^{x} implemented as (2⁴×2⁵)(x−9) within each PE 104, (i.e. pe_macc, the Multiply-Accumulate (MACC) operation within each PE 104. Further, the “−9” can be inherent to the hardware, so the 2\hat{ }4*2\hat{ }5 can be viewed a correction for that shift to get a value of 1. Then a shift-left of x generates 2\hat{ }x.) where the shift-left operation achieves a computationally lightweight approximation of exponentiation. This step leverages the innate efficiency of binary shift operations in hardware to replicate exponential growth patterns with minimal overhead.

Row-Reduce Sum for Denominator: After obtaining the exponentials in each PE 104, the next step for controller 120 is to manage a row-reduce sum operation (e.g. Reduce_Sum operation in the hardware) across the connected PEs. (S:=sum(p)). This summing of results, handled in parallel across the processing elements 104, forms the denominator in the SoftMax computation. By performing the sum in parallel, device 100 can capitalize on its inherent configuration, such as SIMD or spatial architecture, to maintain high computational throughput.

Broadcasting Inverse Sum: Once the sum is calculated, controller 120 computes the reciprocal 1/S (I:=1/S, where S:=sum(p), the row-reduced sum) and broadcasts this value (I) to all PEs 104. This reciprocal is then multiplied with each PE 104's individual result to complete the normalization phase of Softmax. (This mathematical statement is one way to describe the operation, but in a hardware implementation, 1/S is loaded into each PE 104, and then within the pe_convert operation, the 1/S value is left-shifted by x. This is equivalent to multiplying 1/S by 2\hat{ }x.). Centralizing this division operation in controller 120 can optimize resource usage by avoiding repeated calculations within each PE 104.

Scaling Result with pe_convert: In a final optional step, controller 120 utilizes a pe_convert instruction within each PE 104. This optional scaling step may be included in applications where higher precision in the floating-point result is needed, especially in cases where downstream operations are sensitive to minor variations in value. This instruction shifts the accumulated value I:=1/S by a specified amount (in this case, x), effectively multiplying 2^{x} by 1/S to achieve a final scaled output. This can allow each PE 104 to represent the result in floating-point format, finalizing the Softmax computation with sufficient precision for downstream processing.

For greater clarity, the pe_convert Instruction within each PE 104 can facilitate efficient data scaling and format conversion. In a present embodiment, the “pe_convert” instruction shifts the accumulated value (e.g., 1/S) by a specified amount (such as x) and can cast the result into a floating-point format. This operation enables the architecture to maintain computational precision while efficiently scaling results within each PE 104.

By leveraging the unique row-reduce (e.g. Reduce-Sum and Reduce-Max operations) and broadcast capabilities, device 100 performs these steps efficiently, reducing computational bottlenecks. This scaling and approximation sequence can manage the large matrix values common in transformer attention mechanisms, supporting stability across a range of data magnitudes. Thus, the architecture and the scaling strategy in Block 208 together enhance the capability of device 100 to handle data-intensive AI operations, including but not limited to transformers.

To further assist in understanding the foregoing discussion regarding block 208, consider the following mathematical representation:

Assume: softmax(x)_i=e\hat{ }{x_i}/sum(e\hat{ }{x_j}) as usual. Now consider soft2max(x)_i=2\hat{ }{x_i}/sum(2\hat{ }{x_j}). Accordingly:

$$soft 2 max ( x / ln ( 2 ) ) \_i = 2 \hat{} \{ x\_i / ln ( 2 ) \} / sum ( 2 \hat{} \{ x\_j / ln ( 2 ) \} ) = ( 2 \hat{} \{ 1 / ln ( 2 ) \} ) \hat{} \{ x\_i \} \text{} / sum ( ( 2 \hat{} \{ 1 / ln ( 2 ) \} ) \hat{} \{ x\_j \} ) e \hat{} \{ x\_i \} / sum ( e \hat{} \{ x\_j \} ) softmax ( x ) \_i$$

Accordingly, it is possible to apply a prescaling factor of 1/ln(2) to the input values of x, enabling the use of the computationally efficient soft2max function as a substitute for softmax. In implementations of the attention mechanism, this prescaling can be integrated directly into the weights of the Q or K matrices during the compilation phase, thereby reducing the computational overhead associated with runtime scaling adjustments.

To further elaborate on block 212, recall that method 200 can be used in the context of processing the attention equation:

$$Attention ( Q , K , V ) = softmax ( \frac{{QK}^{T}}{\sqrt{{d}_{k}}} ) V$$

Where:
Q, K, and V are all matrices and dx is the dimension size of a “head”.

As an illustrative example, in the Bidirectional Encoder Representations from Transformers Large model, (“BERT-Large”), in one “head”:
d_{K}=64
Q, K, and V are matrices of size [768, 64]
QK^{T} is [768, 768]
(QK^{T})V is [768, 64]

(As understood by those skilled in the art, the BERT-Large model has: 24 layers (or “transformer blocks”) 1024 hidden units per layer 16 attention heads per layer for a total of 340 million parameters).

According to this example, the Q matrix can be treated as a series of vectors (i.e. 768 vectors of size [1, 64] in the example above) so we can use the device 100 to do this calculation.

Note that K and V are used as GEMV coefficients, but they are not fixed. They are a result of a computation with an input X. This means that we cannot pre-load K or V as coefficients before performing a GEMV to get QKT or (QKT)V. K and V are thus loaded into CRAMs 116 as part of method 200. These K and V matrices are thus generated as a series of vectors (i.e. 768 vectors of size [1, 64] in the example above).

According to a present embodiment, these coefficients are loaded diagonally. According to QK^{T}, the K coefficients to be loaded diagonally (this block 212) and then transposed. (Transposing is discussed below in relation to block 216).

Accordingly, device 100 is configured to store coefficients as diagonally-offset. For each coefficient vector, each PE 104 in a row of PEs 104 (per FIG. 1) stores its value in a different CRAM address in the respective CRAM 116. When implemented on an SIMD architecture, one instruction can be used for the same CRAM address for all PEs 194 in the row. (For example, see U.S. patent application Ser. No. 18/903,458 filed Oct. 1, 2024, “SYSTEM AND METHOD FOR LOADING COEFFICIENT MATRICES IN A DIAGONALIZED PATTERN”, the contents of which are incorporated herein by reference, which discusses a hardware method to do diagonal storing and can be combined with the present teachings).

Parallelization is presently preferred for efficiency, which can be implemented as follows:

Multiple integrated versions of device 100 can be used across blocks of 64×64 coefficients. (This can be extended to “dual-issue” blocks of 128×64, but for this illustrative embodiment, the simpler single-issue case is described, but it is presently preferred to implement the more complex dual-issue version);

Eight vectors of coefficients are “read in” or loaded at a time, as per the eight registers 108 for each PE 104; (Again, this can be extended to sixteen or more if there are sufficient registers in a PE 104. Indeed, it can be noted that the larger the block, the more efficient the operation).

For example, for a 64-PE row, as per device 100 with a row of sixty-four PEs 104, a horizontally sliced matrix of 8×64 can be loaded from a complete 64×64 matrix (or other larger size.) To conceptualize, see FIG. 3, where a smaller matrix is sliced vertically into submatrices; i.e. eight blocks of 8×8, which can “fit” into the architecture of device 100 of FIG. 1.

Thusly, each 8×8 block vertically staggers its submatrix using the “k-mask”, a built-in hardware operation that can selectively control data flow within device 100. FIG. 4 shows a segment of twelve PEs 104 each with eight registers 108, generally corresponding to a portion of device 100 shown in FIG. 1. (Links 112, CRAM 116, controller 120, bus 124 are omitted from FIG. 6 for illustrative simplicity, but the same PEs 104 and registers 108 are shown.) On the left, the eight vectors are loaded into each of the registers 108 respective to their corresponding PEs 104. On the right, a change in state of device 100 has occurred according to the data in the registers have been staggered or “offset” according to block 212. A k-mask isolates a subset of PEs 104 which offset the order by swapping data in the registers 108.

Note that this can be optimized by swapping groups of PE 104 only by 1, 2, and 4 positions. In every block of eight PEs 104, one PE 104 swaps by seven (1+2+4), one swaps by six (2+4), one swaps by five (1+4), one swaps by four (4), one swaps by three (1+2), one swaps by one (1), and one does no swap.

In more detail, within an 8×8 block:
Column 0 (Corresponding to PE 104-0) does not change.

### During a 1st Iteration:

1. Columns 1, 3, 5, 7 (corresponding to PE 104-1, PE 104-3, PE 104-5 and PE 104-7) shuffle by one; Notably, column 1 (PE 104-1) has reached its final target position and does not require further shifting.
2. Mask columns 0, 2, 4, 6 (corresponding to PE 104-0, PE 104-2, PE 104-4 and PE 104-6) in each group of eight PEs 104. (The mask columns remain static to anchor the staggered adjustments made in each iteration.)

### During a 2nd Iteration:

1. Columns 2, 3, 6, 7 (Corresponding to PE 104-2, PE 104-3, PE 104-6 and PE 104-7) shuffle by two; Notably, columns 2, 3 (PE 104-2, PE 104-3) have reached their final target position and do not require further shifting.
2. Mask columns 0, 1, 4, 5 (corresponding to PE 104-0; PE 104-1, PE 104-4 and PE 104-5) in each group of eight PEs 104.

### During a 3rd Iteration:

1. Columns 4, 5, 6, 7 (corresponding to PE 104-4; PE 104-5, PE 104-6 and PE 104-7) shuffle by four; Notably, all columns (i.e. PEs 104) have reached their final target position and do not require further shifting.
2. Mask columns 0, 1, 2, 3 in each group of eight PEs 104.

This requires only one 4-bit k-mask (which holds four masks)

At scale, all eight blocks of eight PEs 104 do this in parallel.

FIG. 5 shows the device 100 in the same state as the “loaded and offset” view of device 100 from FIG. 4, but also shows additional PE 104-8, PE 104-9 and PE 104-10 with the relevant example data loaded and offset therein.

Expressing the above more formally, as a specific case for a 64-PE row such as device 100:

Step 1—Initialize Processing Elements (PEs) and k-Mask Configuration:
1. Initialize the matrix of Processing Elements (PEs) 104, each associated with a set of registers 108. Configure a k-mask to define the subset of PEs within each group that will be activated for staggered shifting.
   Step 2—Load Data into Registers:
1. Load data vectors into the registers 108 of each PE 104 in preparation for staggered alignment.

### Step 3—First Iteration—Shift by 1 Position:

1. Apply the k-mask to activate a subset of columns (e.g., columns 1, 3, 5, 7) within each group of PEs. Shift data within the activated PEs by one position. The remaining columns (e.g., columns 0, 2, 4, 6) remain unshifted to serve as anchors.

### Step 4—Second Iteration—Shift by 2 Positions:

1. Reconfigure the k-mask to activate a different subset of columns (e.g., columns 2, 3, 6, 7) for the next shift operation. Shift the data within the activated PEs by two positions, while columns that have already reached their final position are masked to remain static.

### Step 5—Third Iteration—Shift by 4 Positions:

1. Apply the k-mask to a final subset of columns (e.g., columns 4, 5, 6, 7) within each group of PEs, shifting the data by four positions. After this shift, all columns within the group have reached their target positions, and no further shifting is required.

### Step 6—Finalize Staggered Alignment:

1. Confirm that all data in the matrix has achieved the staggered, or offset, alignment across PEs. Each 8×8 block within the matrix now holds data aligned for optimal parallel processing, with staggered entries based on the applied shifts.

### Step 7—Parallelize Across Multiple Blocks:

1. Execute the above steps in parallel across all groups of eight PEs in the matrix. By scaling the method across multiple blocks, the configuration is established efficiently, supporting large matrix sizes.

Expressed in more general terms, for an n×n matrix:

### Step 1—Initialize Processing Elements (PEs) and Mask Configuration:

1. Set up the n×n matrix of Processing Elements (PEs) 104, each equipped with registers 108. Define a mask that determines the subset of PEs within each row (or column group) to be activated for staggered shifting, based on the required positional offset for the target alignment.
   Step 2—Load Data into Registers:
1. Load data vectors into the registers 108 associated with each PE 104 across the n×n matrix, preparing the data for staggered alignment.
   Step 3—Iterative Shift Process: Starting with 1 Position Shift
1. Apply the mask to activate a subset of PEs within each row or column group and perform an initial shift by one position. Non-activated PEs remain static to serve as anchoring points.
   Step 4: Continue Iterative Shifts with Doubling Increments
1. For each subsequent iteration, increase the shift offset by doubling the previous shift value (i.e., 2, 4, 8, . . . positions) until the offset reaches or exceeds n/2. For each iteration:
   i. Adjust the mask to activate only the subset of PEs that have not yet reached their target position.
   ii. Shift data in the activated PEs according to the current offset, while leaving already-aligned PEs unaffected.

### Step 5—Complete the Staggered Alignment: (Optional)

1. After all iterations are complete, verify that each PE in the n×n matrix has reached its target staggered alignment.

### Step 6—Scale Process Across Multiple Matrix Blocks: (Optional)

1. If the matrix is subdivided into blocks (e.g., in a larger structure of m×m submatrices, where each submatrix is n×n), repeat Steps 1-5 for each block in parallel.

Continuing to explain block 212, each Processing Element (PE) 104 utilizes its k-mask capability for loading of coefficients across CRAM 116 without overwriting unintended values. (FIG. 6 shows a representation of diagonally offset coefficients, as will be explained in further detail below.)

Specifically, the k-mask allows selective read-modify-write cycles for data loading. For each iteration:
Masked PEs 104 read data from CRAM 116 into a register 108;
The k-mask controls which PEs 104 in each 8-PE block are actively modifying values within the CRAM 116, enabling a controlled staggered effect;
After modification, all PEs 104 within the block write their respective register 108 values back to CRAM 116 to complete the iteration, maintaining integrity across the coefficient loading.

(Alternatively, future hardware embodiments could enable a direct masked-write operation to CRAM 116, bypassing intermediate register modifications and potentially increasing throughput by reducing memory access cycles.)

After completing 64 iterations, device 100 will have written a diagonal “stripe” of width eight across the CRAM 116. (In more technical terms, the “stripe” can be understood as a sequentially written, diagonally aligned subset of coefficients spanning a width of eight CRAM 116 addresses, whereby each successive coefficient occupies a unique memory address in a diagonally offset manner within the memory array.) FIG. 6 illustrates this process, beginning with three consecutive k-mask window positions in black, where only the coefficients within the highlighted window are written sequentially to three consecutive CRAM 116 addresses. In FIG. 6, the final state shows an 8-wide diagonal stripe of coefficients across the sixty-four CRAM 116 addresses, effectively utilizing diagonal-offset to maximize parallelization in subsequent GEMV calculations.

In addition, FIG. 6 demonstrates the write process for creating this 8-wide diagonal stripe. Initially, only a limited set of CRAM addresses within each row receive the coefficient values as determined by the k-mask window. As the window shifts, each CRAM address in the diagonal alignment is progressively populated, allowing device 100 to efficiently complete the diagonal loading across CRAMs 116.

This 8-wide diagonal stripe configuration across the CRAM 116 supports the efficient execution of GEMV operations across each row of PEs 104 by ensuring each PE 104 receives appropriately staggered (offset) data for parallel processing.

Block 216, the transposition of the loaded coefficients, will now be explained in greater detail. As noted in earlier descriptions, the QK^{T} calculation has the K matrix coefficients undergo transposition to achieve a matrix alignment for subsequent attention calculations. The transposition at block 216 aligns rows and columns of the K matrix, enabling each PE 104 to operate on the corresponding coefficients during Generalized Matrix-Vector (GEMV) operations.

Once the coefficients have been loaded diagonally within device 100, a unique property of these diagonally-offset coefficients simplifies the transposition process. FIG. 7 illustrates a standard coefficient matrix compared to a diagonally-offset coefficient matrix, demonstrating how each diagonally-offset column (indicated in red) corresponds to a traditional column in the matrix. Likewise, each diagonal line within the matrix (shown in blue) corresponds to a row in the standard configuration.

FIG. 8 highlights the result of applying a transposition to a standard coefficient matrix, where rows and columns effectively swap positions. To achieve this effect within device 100, the system employs a skewing process, as shown in FIG. 9. Here, the diagram shows that a skewing operation, followed by a wrap-around rotation, causes the diagonally-offset columns to align vertically, converting them into rows for the purpose of matrix manipulation.

Therefore, skewing the diagonally-offset coefficient matrix is functionally equivalent to performing a transposition operation. This equivalence is visually demonstrated in FIG. 10, where the skewed configuration aligns the coefficients appropriately for the GEMV calculations in subsequent blocks. Using the inherent structure of device 100, this skewing-based transposition optimizes both processing speed and memory access efficiency.

This skewing or ‘wrap-around’ operation can be performed using the “rotator cuff” links 112 mechanism within device 100. By assigning each “CRAM row” a distinct identifier from zero to sixty-three, sequentially from the bottom to the top (as depicted in FIG. 10), controller 120 can control the rotation and transposition process. Each PE 104 in device 100 then executes the skewing operation, aligning the coefficients into the desired transposed configuration for further processing within the GEMV framework.

Recall a “CRAM row” refers to a specific indexed set of coefficient values across all CRAMs 116, one in for each PE 104, that collectively form a contiguous data “row” accessible across the PEs 104. To elaborate, a “CRAM row” represents the equivalent storage address across all CRAM units within the array of PEs. When discussing operations involving “rotating” or “skewing” a CRAM row, it implies that each CRAM unit 116 for each PE 104 will access the same indexed row (e.g., row 0 or row 63) simultaneously, allowing synchronized data manipulation across the entire bank of PEs.

In practical terms:

Row Indexing Across PEs: Each CRAM 116 has a series of storage locations (e.g., 64 addresses), and all CRAMs in the 64 PEs 104 have identically indexed addresses.

CRAM Row Alignment: By designating a CRAM row, we refer to accessing the same address across the CRAM units in each PE, allowing device 100 to access a synchronized set of coefficients across all processing elements.

Functional Role in Transposition: During the skewing or transposition process, a CRAM row's coefficients are rotated or aligned across the PEs 104 using the “rotator cuff” links 112, facilitating operations that require transposed data alignment. For instance, loading CRAM row zero across all PEs 104 and rotating it achieves a diagonally offset configuration, as illustrated in FIG. 10, preparing the data for GEMV calculations.

Thus, in the context of device 100, a CRAM row enables alignment and manipulation of coefficients across all processing elements by referring to a consistent set of data addresses across the PEs' 104 individual CRAM 116.

Each CRAM row, once assigned its identifier, undergoes a rotation procedure controlled via links 112 to facilitate the skewing operation. Device 100 is configured to load a row of data from CRAM 116 into link 112, perform a rotation by a specified count (denoted as N), and then store the rotated data back into CRAM. The rotator cuff links 112 support both clockwise and counterclockwise rotations, enabling the first half of CRAM rows to rotate in one direction (from 0 to 31 positions) and the second half in the opposite direction (from 32 to 1 positions).

Recall, there are four parallel groups of rotator links 112 within device 100, enabling four CRAM rows to undergo rotation operations concurrently. Each link 112, acting as a “rotator cuff,” provides connectivity and buffering capabilities to facilitate independent data rotation and temporary storage between adjacent PEs 104. This parallel configuration enables throughput by stacking rotation tasks, allowing longer rotations to be processed simultaneously. By coordinating these concurrent rotations across the PEs 104, device 100 arranges the diagonally-offset coefficients into the transposed configuration for the GEMV operations. Total rotation time can be reduced, or even minimized, by grouping the longer rotations together, especially if the group has all the same, or substantially the same, rotations.

The rotation mechanism provided by links 112 in device 100 can also be configured to accommodate dual-issue GEMV operations, as well as bi-directional GEMV operations can be supported.

Having completed block 216, the remainder of method 200, block 220, block 224, block 228 and block 232 can be completed according to the aforementioned general description.

### Broad Variations:

It should be recognized that features and aspects of the various examples provided above can be varied and/or combined into further examples that also fall within the scope of the present disclosure. For example, device 100's configuration can also allow for “flat” storage of coefficients. Indeed, the “height” of the input X matrix can vary, which then modifies the “height” of the Q matrix. This means that the number of Q vectors can vary. When it is large, it is efficient to spend the extra cycles to write coefficients to CRAM diagonally and transposed, as described in relation to block 212 and block 216, because those cycles will be amortized over a large number of Q vectors. But there are applications of Transformers where only a single vector of Q is processed, but the entirety of a large number of K and V vectors are still used in the calculation. In these cases, the overhead of storing V diagonally, and K diagonally and transposed, is much greater than the cycles to process the single Q vector. In these cases we want to be able to store the coefficients “flat” (i.e. store each vector into one CRAM address, with no diagonalization or transposition). In this case, each Q vector can be written directly into CRAMs 116 without offset or transposition, simplifying memory access when only a single vector of Q is processed against all K and V vectors. However device 100 can still perform the GEMV operations as if the coefficients were diagonalized, or diagonalized and transposed.

FIGS. 11 and 12 illustrate the two main GEMV modes—Broadcast and Reduce—that device 100 can employ based on the configuration of the coefficient data.

In FIG. 11, the left side illustrates a standard matrix-vector multiplication. Here, the blue row of coefficients performs a dot product with the green vector to generate the first red output. Each subsequent row of coefficients then follows this process to produce additional outputs. On the right side of the figure, a different approach is shown in a row of PEs 104. In this setup, the first input element of the green rotator cuff is broadcasted to all PEs 104, where it is multiplied by the coefficients stored in the first CRAM 116 address, which is depicted as a column. This process is then repeated for each subsequent input element, with the second input element being broadcasted to multiply with the coefficients in the second CRAM 116 address, and so forth.

In FIG. 11, the matrix-vector multiplication process utilizes the hardware structure of device 100, as depicted in FIG. 1. On the left side of FIG. 11, a traditional matrix-vector multiply operation is illustrated, where each row of coefficients stored in the CRAM 116 performs a dot product with a vector of input values. In this configuration, each PE 104 accesses a specific set of coefficients from its respective CRAM 116, aligning with the input vector for multiplication and accumulation steps. This sequentially produces each output based on the cumulative dot products performed across the rows.

On the right side of FIG. 11, device 100 executes a GEMV-broadcast mode, wherein a single input vector element is broadcast across all PEs 104, enabling each PE to perform a multiply-accumulate (MACC) operation with the coefficient stored in its respective CRAM 116. This process leverages the connectivity of “rotator cuff” links 112, which facilitate data flow between adjacent PEs 104, allowing each element of the input vector to propagate across the entire row of PEs 104. As each input element is broadcast, each PE 104 retrieves a corresponding coefficient from its CRAM 116 and performs a multiply-accumulate operation. The CRAM 116 addresses increment in sequence, aligning each broadcast input with the intended coefficient set across PEs 104. This synchronized structure supports a matrix-vector multiplication process, with the controller 120 coordinating the broadcasting and accumulation across device 100. This configuration allows device 100 to execute the GEMV operation in a novel manner that mimics a standard matrix-vector multiply. To elaborate on the steps illustrated in FIG. 11
Step 1: An input vector element is loaded into a dedicated data pathway of links 112, referred to as a “rotator cuff”, associated with a row of 64 processing elements (PEs) 104.
Step 2: The first element of the input vector, from PE 104-0, is rotated into the controller 120. Concurrently, this input element rotates around the rotator cuff.
Step 3: Controller 120 then broadcasts this input element to all PEs 104.
Step 4: Each PE 104 performs a Multiply-Accumulate (MACC) operation with the broadcasted input element and the first coefficient stored in its associated CRAM 116 address.
Step 5: The next input vector element is rotated into the controller 120. Controller 120 increments the CRAM address to retrieve the subsequent coefficient, and the process repeats as the next element is broadcast to all PEs 104.
Step 6: For applications with dual-issue capabilities, two “rotator cuffs” may be employed. In this configuration, two input elements are rotated into controller 120 simultaneously. Controller 120 then broadcasts both inputs to all PEs 104 in each iteration, enabling parallel processing and increased throughput.

This broadcast-based method can reduce overhead compared to some of the prior art systems associated with writing diagonalized or transposed coefficients to CRAM 116.

Referring now to FIG. 12, in a standard transposed GEMV operation, as depicted on the left side of FIG. 12, a single column of coefficients performs a dot product with an entire input vector to produce one output. Here, each element in the blue column of coefficients is multiplied with the corresponding element in the green input vector to yield the first red output.

In GEMV-Reduce mode, shown on the right side of FIG. 12, the device 100 uses each PE 104 to achieve this dot product operation. All PEs 104 clear their accumulators to ensure that no residual values interfere with the current calculation. Each PE 104 then performs a Multiply-Accumulate (MACC) operation, where it multiplies its input value by the corresponding coefficient stored in its CRAM 116.

Following the MACC operations, a “Reduce Sum” operation is executed to aggregate the results from all PEs 104, thereby accumulating the partial products to obtain the final output value for the dot product. In this configuration, the “rotator cuff” functions of links 112 are used to store and manage the accumulated results from each PE 104 without rotating the input values, maintaining the static position of inputs across PEs. This mode provides an efficient approach for handling transposed matrix-vector operations by reducing the need for data rotation and focusing on summing accumulated results.

To elaborate the steps in FIG. 12:
Step 1: Load the input vector into a cuff for a row of 64 PEs.
Step 2: Each PE 104 clears its accumulator (ACC) to reset for the current operation, ensuring no residual values affect the calculation.
Step 3: Each PE 104 performs a Multiply-Accumulate (MACC) operation using the input value and the coefficient stored in the first CRAM address.
Step 4: A Reduce_Sum operation aggregates the results from all PEs' 104 accumulators and sends the summed result to the controller 120.
Step 5: The controller 120 places the accumulated result in a separate cuff designated for output storage.
Step 6: Advance the “rotator cuff” of links 112 by rotating the result cuff one position. The inputs themselves are not rotated. Put in other words, the input rotator cuff remains static, serving as a source for data input. In contrast, the result cuff rotates independently, cycling through data slots to complete alignment or computation, so that all 64 positions are filled sequentially without altering the original input configuration.
Step 7: Increment the CRAM 116 address to access the next coefficient for the following MACC operation, and repeat as needed.

This GEMV-Reduce approach can require additional cycles compared to prior art computing devices. However, it avoids the computational overhead associated with pre-writing diagonalized and transposed coefficients to CRAM 116, optimizing performance for specific configurations.

It is noted that the combination of block 220 (GEMV), block 224 (Softmax) and/or block 228 (attention) all benefit from block 208 (scaling), block 212 (diagonal offset) and block 216 (transposition). However, in variants it can be also noted that other operations can benefit from block 208 (scaling), block 212 (diagonal offset) and/or block 216 (transposition), and thus one or more can stand alone as separate embodiments of this specification. For example, rather than block 220 (GEMV), other matrix operations or multiplications can benefit from the teachings herein. As another example, rather than block 224, other types of element-wise operations can benefit, such as normalizations, summations or certain non-linear transformations such as those used in activations. As a further example, rather than block 228, various aggregation, reduction or finalization operations can be implemented, such as pooling, summing, averaging or other types of summary calculations. Thus, in general terms, block 220 (GEMV), block 224 (Softmax) and/or block 228 (attention) can be generalized as a multi-step computational operation based on a diagonally-offset, transposed set of transposed coefficients stored in a plurality of processing elements. Likewise, in similar general terms, block 204 comprises receiving one or more matrices into a plurality of processing elements for parallel processing. These matrices can be scaled, offset, and transposed as needed to enable efficient multi-step computational operations, such as those based on diagonally-offset, transposed coefficients stored across the processing elements.

The present specification thus provides a novel device and method for efficiently executing transformer attention mechanisms and other matrix-intensive computations within a parallelized architecture. The disclosed system addresses the computational demands of attention layers, which typically exceed the capability of standard GEMV accelerators. Without these innovations, such computations would require a GPU, which is limited in availability per instance and performs slowly in this context, or a RISC controller, which also operates slowly and is generally limited to one instance per bank.

By leveraging unique features of described hardware configuration in conjunction with GEMV operations, this device 100 parallelizes computations across a row of SIMD PEs, maximizing processing efficiency. Specific advantageous features include:

Exponential Approximation (e\hat{ }x):

Each PE incorporates a shift feature within the MACC that enables a hardware-efficient approximation of the exponential function, e\hat{ }x. This exponential approximation is achieved with minimal additional hardware, reducing the need for complex exponential calculations typically required in transformer operations.

The method incorporates pre-processing steps (fused with a preceding dense calculation) to simplify the exponential approximation, further enhancing performance. Additional hardware features, such as reduce_max and reduce_sum, support Softmax computations by enabling efficient parallel accumulation and normalization across the PEs.

### Diagonally-Offset Coefficient Loading:

Using the k-mask, the device vertically staggers submatrices across the PE row in parallel blocks. This configuration allows for efficient loading of coefficients in a diagonal offset pattern, which aligns well with GEMV operations.

The k-mask and “rotator cuff” enable a sliding window of coefficients to be stored and shifted in a wide diagonal stripe across CRAM, allowing for quick access and manipulation of coefficients across the PEs. This setup minimizes data movement and enhances memory access efficiency.

### In-Situ Transposition of Coefficients:

The architecture allows for in-situ transposition of coefficients within CRAM, facilitated by the rotator cuff links. This is advantageous for operations requiring matrix transposition, as it avoids the need to reformat data externally.

A plurality of (in the present examples, four) “rotator cuffs” can operate in parallel, supporting multiple rows of data to be transposed and rotated simultaneously, further increasing throughput and reducing latency.

### GEMV Modes: Broadcast and Reduce:

The device supports both GEMV+broadcast and GEMV+reduce operations. GEMV+broadcast allows for matrix-vector multiplication when coefficient diagonalization is inefficient, by broadcasting a single input across all PEs.

GEMV+reduce enables efficient summation and dot-product operations in transposed configurations. This mode is particularly useful when calculating matrix-vector products where each column of coefficients must interact with the entire input vector, as it reduces data rotation requirements and leverages parallel accumulation across the PEs.

In summary, the disclosed device and method provide an architecture that enhances the efficiency of attention mechanisms and other computationally intensive tasks typically associated with transformers and machine learning. By addressing common computational bottlenecks with specialized hardware features and a parallelized approach, this invention reduces the need for external processing resources and optimizes performance across matrix operations.

The scope of the present specification is defined by the claims attached hereto.

1. A method of operating a computing device having a plurality of processing elements connected to a controller, the method comprising:
receiving, by the controller, at least a portion of an input matrix into the processing elements; the input matrix having undergone a pre-scaling operation;
loading, by the controller, a coefficient into a memory unit associated with each of the processing elements in a diagonally-offset configuration;
transposing the coefficients by shifting each coefficient from its respective memory unit in a first processing element to another memory location in an adjacent processing element;
executing, within the processing elements, a computational operation based on the transposed coefficients within the processing elements; and,
controlling, by the controller, an output device based on the executed computational operation.

2. The method of claim 1 wherein the computational operation is a multi-step computational operation based on one or more of a GEMV operation, a Softmax operation, and/or an attention operation.

3. The method of claim 1 wherein the pre-scaling operation approximates e\hat{ }x as 2\hat{ }x by applying a pre-scaling factor.

4. The method of claim 3, wherein the approximation is achieved by applying a hardware bit-shifting operation within each processing element.

5. The method of claim 1, wherein the diagonally-offset configuration of coefficients is achieved using a mask-controlled selective shifting operation across a subset of processing elements.

6. The method of claim 1, wherein the transposing of coefficients includes a rotation operation performed by a rotator link connecting adjacent processing elements, the rotation configured to align coefficients for matrix-vector multiplication.

7. The method of claim 1, wherein the pre-scaling operation includes subtracting the maximum value from all elements in the input matrix to enhance numerical stability during subsequent computations.

8. The method of claim 1, wherein the computational operation comprises a GEMV-Broadcast operation in which a single input element is broadcast across all processing elements.

9. The method of claim 1, wherein the computational operation comprises a GEMV-Reduce operation that aggregates intermediate results from multiple processing elements using a reduce-sum operation.

10. The method of claim 1, wherein the transposition of coefficients includes a skewing operation that aligns diagonally-offset coefficients for parallel processing.

11. The method of claim 1, further comprising performing a normalization operation on the results of the computational operation by broadcasting an inverse sum value across the processing elements.

12. The method of claim 1, wherein the memory unit associated with each processing element is a coefficient random access memory (CRAM) configured to store at least 64 coefficients.

13. The method of claim 1, further comprising executing a computational operation in which two separate computational operations are performed in parallel by distinct groups of processing elements.

14. The method of claim 1, wherein the diagonally-offset configuration is achieved by sequentially writing coefficients into memory locations in a staggered pattern across the processing elements.

15. The method of claim 1, wherein the transposing of coefficients utilizes four parallel groups of rotator links to perform concurrent rotation operations across subsets of the processing elements.

16. The method of claim 1, wherein the computational operation includes a Softmax operation that utilizes the pre-scaled coefficients for exponentiation and normalization.

17. The method of claim 1, further comprising performing an activation operation, including one of pooling, summation, or averaging, on the output of the computational operation.

18. The method of claim 1, wherein the input matrix is divided into smaller submatrices, each submatrix being processed independently across the processing elements.

19. The method of claim 1, wherein the computational operation involves a bi-directional GEMV operation, wherein input data is processed simultaneously in both forward and reverse directions across the processing elements.
